(19) United States
(12) Patent Application Publication
(10) Pub. No.: US 2010/0314419 A1
(43) Pub. Date: Dec. 16, 2010

(54) POWDER DISPENSER

(76) Inventors: Bryan Real, West Dundee, IL (US); Robert Long, Lake in the Hills, IL (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/814,913

(22) Filed: Jun. 14, 2010

Related U.S. Application Data
(60) Provisional application No. 61/186,620, filed on Jun. 12, 2009.

(51) Int. Cl. G01F 11/20; B67D 1/00

(52) U.S. Cl. 222/236; 222/1; 222/39; 222/52; 222/413

(57) ABSTRACT

The present disclosure includes a powder dispensing assembly including a housing, a hopper assembly comprising one or more hoppers for containing powders to be dispensed contained within said housing, an outlet passage engaged with the hopper assembly for discharging selected amounts of powder from the hopper assembly and a powder moving assembly contained within each hopper for moving powder within the hopper assembly to the outlet passage. A trigger mechanism is also incorporated which initiates the powder moving assembly for dispensing the powder. A printed circuit board (printed circuit board) is activated by the trigger mechanism and sends a signal to a media content delivery system. The media content delivery system delivers an audio, video, or audiovisual message to the user of the dispensing assembly.

### CROSS-REFERENCE TO RELATED APPLICATIONS

This application claims the benefit of U.S. Provisional Application No. 61/186,620 filed Jun. 12, 2009, entitled POWDER DISPENSER, which is hereby incorporated herein by reference in its entirety.

### BACKGROUND OF THE INVENTION

The present invention generally relates to a powder dispensing assembly and the like, and in particular to powder dispensing assemblies incorporating point-of-use messaging capabilities.

### SUMMARY OF THE INVENTION

One aspect of the present disclosure includes a powder dispensing assembly including a housing, a hopper assembly disposed within the housing comprising at least one hopper and at least one powder moving assembly wherein the hopper is configured to contain dry powders to be dispensed, at least one outlet passage engaged with the hopper assembly for discharging selected amounts of powder from the hopper assembly, a trigger mechanism, a printed circuit board operably coupled to the trigger mechanism and a media content delivery system.

Another aspect of the present disclosure includes a method of delivering a point-of-use message to a user, the steps including, providing a dry powder dispensing assembly having a housing, a trigger mechanism, a printed circuit board, and a media content delivery system. Triggering the trigger mechanism occurs when a user of the powder dispensing assembly activates the trigger mechanism. The trigger mechanism then sends a signal to the printed circuit board. The printed circuit board the sends a signal to the media content delivery system, and the media content delivery system delivers a message to the user.

Another aspect of the present disclosure includes a powder dispensing assembly having a hopper assembly with at least one hopper and at least one powder moving assembly. The powder dispensing assembly further including at least one trigger mechanism which is operably connected to a printed circuit board, wherein the printed circuit board is capable of being triggered by the triggering mechanism. The powder dispensing assembly further includes at least one media content delivery system operably connected to the printed circuit board and capable of being activated by the printed circuit board to deliver a message to a user.

Another aspect of the present disclosure is a powder dispensing assembly that provides a dry powder to a user.

Another aspect of the present disclosure is a powder dispensing assembly that provides a finished beverage to a user.

Another aspect of the present disclosure includes a powder dispensing assembly, wherein the trigger mechanism comprises a button disposed on the exterior of the housing which is pushed by the user to activate the auger assembly and printed circuit board.

Another aspect of the present disclosure includes a powder dispensing assembly, wherein the trigger mechanism comprises a sensor unit which detects the presence of a user of the powder dispensing assembly using audio sensing, ultrasonic sensing, infrared sensing, optical sensing, motion detection or the like to activate the auger assembly and printed circuit board.

Another aspect of the present disclosure includes a powder dispensing assembly, wherein the printed circuit board senses that a pre-recorded video and/or audio message played through a video and/or audio unit has ended and applies a control signal which inhibits the trigger mechanism from sending another signal to the printed circuit board for a controlled period of time.

Another aspect of the present disclosure includes a powder dispensing assembly, wherein the printed circuit board is readily programmable to edit, modify, or create a pre-recorded video and/or audio message to be played through the audio unit.

Another aspect of the present disclosure includes a powder dispensing assembly, wherein the printed circuit board is programmable so as to detect which of a plurality of triggering mechanisms has been actuated so as to correspond with a select pre-recorded video and/or audio message to be played through the video and/or audio unit.

Another aspect of the present disclosure includes a powder dispensing assembly, wherein a display screen runs continuously delivering information and advertising messages without the need for a triggering mechanism.

Another aspect of the present disclosure includes a powder dispensing assembly, wherein the display screen or printed circuit board is adapted to receive information regarding information and advertising messages which can be downloaded to the dispensing assembly over a network connection.

Yet another aspect of the present disclosure includes a method of delivering point-of-use advertising through a video and/or audio unit incorporated within a powder dispensing assembly which dispenses powder when triggered by the user, which then triggers the video and/or audio unit to deliver a pre-recorded video and/or audio message.

These and other features, advantages and object of the present disclosure will be further understood and appreciated by those skilled in the art upon studying the following specification, claims, and appended drawings.

### BRIEF DESCRIPTION OF THE DRAWINGS

The foregoing aspects and many of the attendant advantages of the powder dispensing assembly of this disclosure will become more readily appreciated by reference to the following detailed description, when taken in conjunction with the accompanying drawings, wherein:

FIG. 1 is a perspective view of one embodiment of a powder dispenser assembly of the present disclosure;

FIG. 2 is a front elevational view of the powder dispenser assembly of FIG. 1;

FIG. 3 is a side elevational and partial sectional view of the powder dispenser assembly, taken from the right of FIG. 2;

FIG. 4 is a rear elevational view of the powder dispenser assembly of FIG. 1;

FIG. 5 is a side elevational view of the powder dispenser assembly, taken from the left of FIG. 1;

FIG. 6 is a top plan view of the powder dispenser assembly of FIG. 1;

FIG. 7 is a top plan view of the powder dispenser assembly of FIG. 1;

FIG. 8 is a perspective view of a second embodiment of the powder dispenser assembly of the present disclosure;

FIG. 9 is a cross-sectional view of the second embodiment of the powder dispenser assembly of the present disclosure of FIG. 8;

FIG. 10 is a fragmentary perspective view of the second embodiment of the powder dispenser assembly of the present disclosure of FIG. 8;

FIG. 11 is a perspective view of a third embodiment of the powder dispenser assembly of the present disclosure;

FIG. 12 is a front elevational view of the a third embodiment powder dispenser assembly of FIG. 11;

FIG. 13 is a cross-sectional view of the third embodiment of the present disclosure, taken at line 13-13 of FIG. 12; and

FIG. 14 is a side elevational view of the third embodiment of the powder dispenser assembly, taken from the right of FIG. 11.

### DETAILED DESCRIPTION OF THE PREFERRED EMBODIMENTS

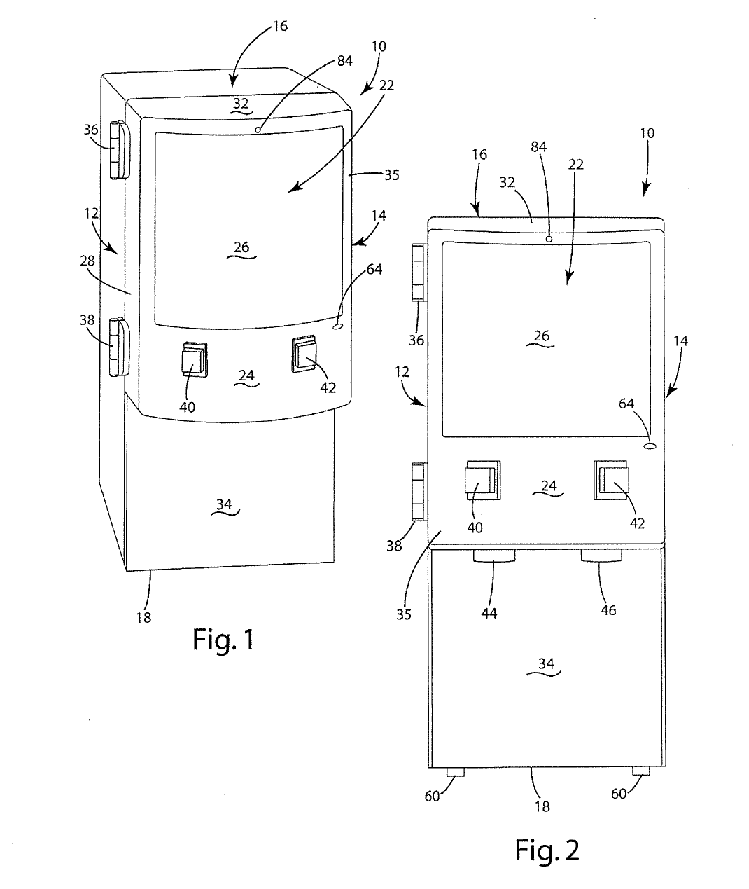

For the purposes of description herein, the terms “upper,” “lower,” “right,” “left,” “rear,” “front,” “vertical,” “horizontal,” “top,” “bottom” and derivates thereof shall relate to the invention as orientated in FIG. 1. However, it is to be understood that the powder dispenser disclosed herein may assume various alternative orientations, except where expressly specified to the contrary. It is also to be understood that the specific devices and processes illustrated in the attached drawings, and described in the following specification, are simply exemplary embodiments. Hence, specific dimensions and other physical characteristics relating to the embodiments disclosed herein are not to be construed as limiting, unless expressly stated otherwise.

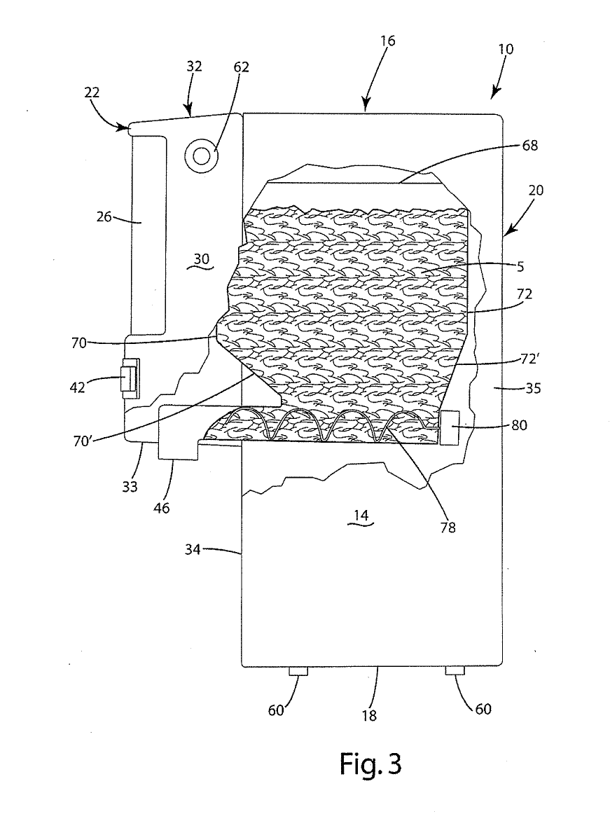

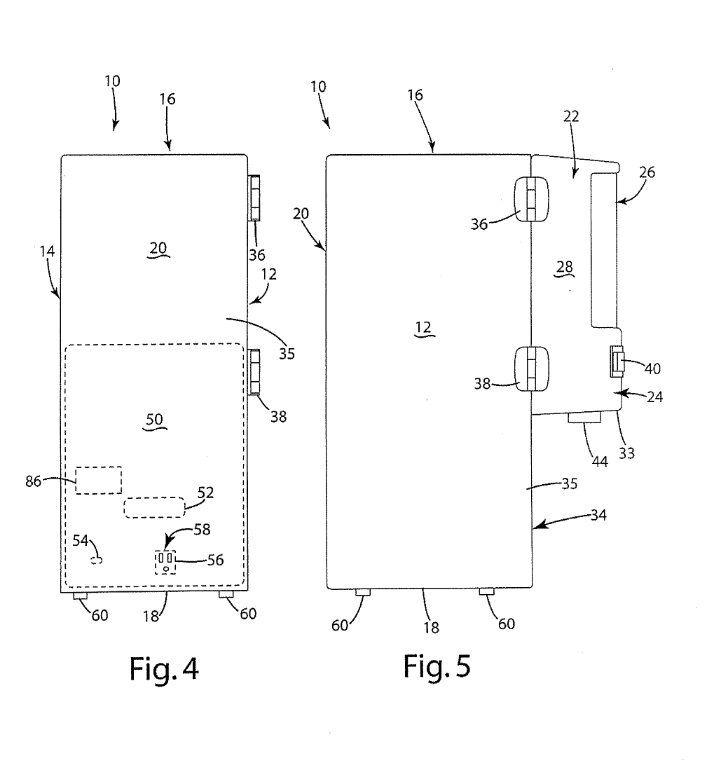

As shown in FIGS. 1 and 2, the reference numeral 10 generally designates a powder dispenser assembly having a first side panel 12 and a second side panel 14. The powder dispenser assembly 10 further comprises a top panel 16, a bottom panel 18, and a rear panel 20 (FIG. 4). The front of the powder dispenser assembly 10 comprises a door 22 having a front panel 24, a preferably illuminated display panel 26 for media content or advertising and such, a first side panel 28, a second side panel 30 (FIG. 3), a top panel 32, and a bottom panel 33 (FIGS. 3 and 7). The front of the powder dispenser assembly 10 further comprises a dispensing panel 34 disposed adjacent to where dry powder is dispensed. Together, the side panels 12 and 14, the top panel 16, the bottom panel 18, the rear panel 20, the door 22, and the dispensing panel 34 make up the housing 35 of the powder dispenser assembly 10. The door 22, the door associated panels 24, 28, 30, 32 and 33, and panels 12, 14, 16, 18, 20 and 34 that make up the housing 35 of the powder dispenser assembly 10 are generally made of an injection molded plastic, although other materials will be appreciated by those skilled in the art.

The door 22 further comprises hinges 36 and 38 (FIG. 1) operably coupled to the side panel 12 of the housing 35 of the powder dispenser assembly 10. The door 22 is moveable between a closed position (FIG. 1) and an open position (not shown) which allows the user access to the inside of the powder dispenser assembly 10. In the embodiment shown in FIGS. 1 and 2, the door 22 further comprises a trigger mechanism in the form of buttons 40 and 42 which are used by the user of the powder dispenser assembly 10 to initiate the dispensing of the select dry powder.

As shown in FIG. 2, the powder dispenser assembly 10 further comprises dispenser nozzles 44 and 46 which, as shown in FIGS. 3 and 5, extend down from the bottom panel 33 of the door 22 over the dispensing area adjacent the dispensing panel 34 and are spaced from the surface or drip tray (not shown) such that the user can get a standard size beverage receptacle, such as a coffee cup, into the dispensing area for the dispensing of dry powder. As best shown in FIG. 3, a partial sectional view of the housing 35 is depicted wherein the housing 35 encloses one or more powder hoppers 68 in a hopper assembly (having at least one hopper), containing a dry powder 5 to be dispensed, with moveably convergent vertical front and rear side walls 70 and 72, respectively, which have lower portions 70′ and 72′ which are inclined downward towards the center of the hopper 68. A dry powder moving assembly disposed within each hopper 68 is used to advance the powder 5 into a dispenser nozzle 44 or 46 for a predetermined time, corresponding to a predetermined quantity of powder to be dispensed. In the embodiment shown in FIG. 3, the powder moving assembly is in the form of an elongate helical auger 78 powered by a motor 80 which rotates when activated by a trigger mechanism or other like device thereby advancing powder toward a nozzle (44 or 46 depending on the trigger mechanism triggered) for dispensing a select dry powder from the dispensing assembly 10. In this embodiment, the trigger mechanism is in the form of buttons 40 and 42 which will initiate the dispensing of varied dry powders from one hopper 68 or another, allowing one powder dispenser assembly 10 to provide the user with multiple choices of dry powder for dispensing.

As shown in FIG. 4, the rear panel 20 further comprises a lower panel 50 having a handle 52 used to remove the lower panel 50 to allow the user access inside the housing 35 of the powder dispenser assembly 10. The lower panel 50 further comprises access points 54 and 56 which allow for access into the interior of the housing 35 of the powder dispenser assembly 10 when the lower panel 50 is attached to the rear panel 20. In the embodiment shown in FIG. 4, the access point 56 is being used for a power receptacle 58 which will connect to a power cord (not shown) which extends from the powder dispenser assembly to a power source (not shown). Other embodiments contemplate a power cord which is integral to the dispenser assembly 10 and will use an access point such as access point 54 for running the power cord to a power source. As shown in FIGS. 4, 5 and 7, the bottom panel 18 further comprises feet 60, which are generally made of a rubberized material to provide a non-slip engagement of the powder dispenser assembly 10 with the surface on which the powder dispenser assembly 10 is placed.

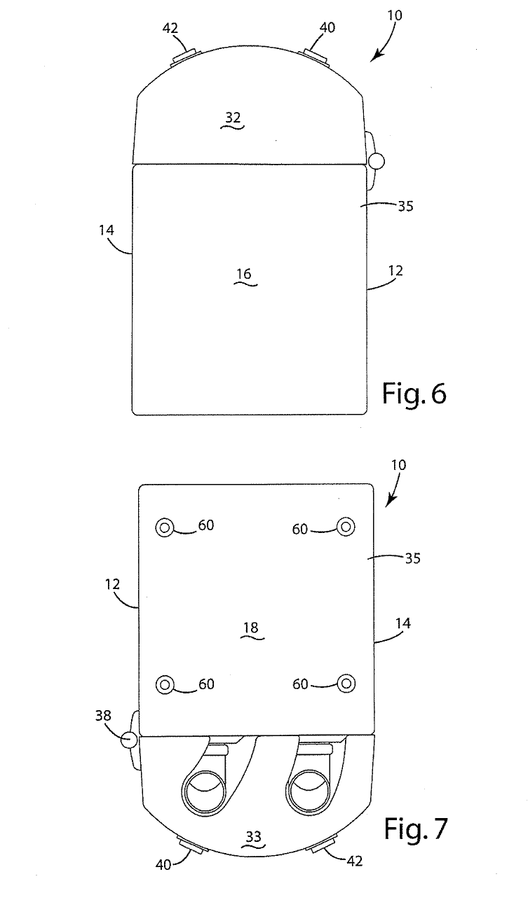

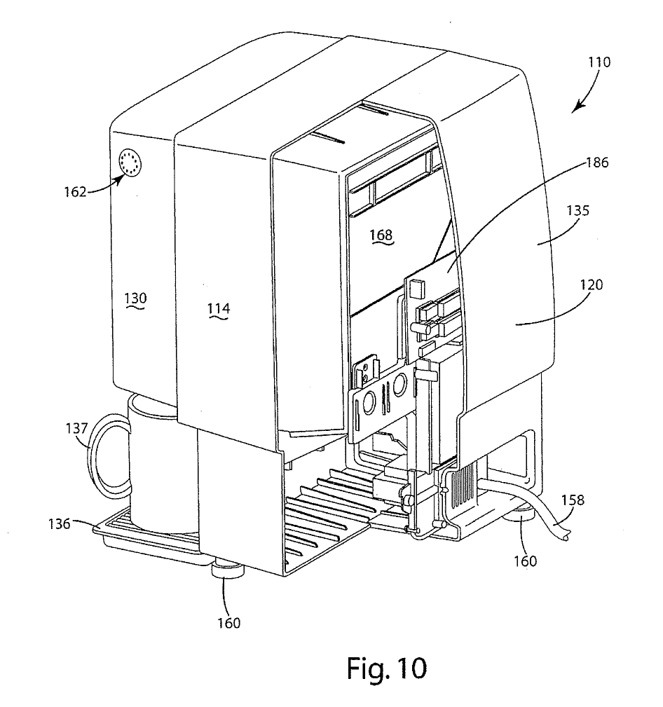

The embodiment as shown in FIGS. 1-7, and as discussed in more detail below, further comprises trigger mechanism which can be in the form of a sensory unit 64 (FIGS. 1-2), a button such as buttons 40 and 42 (as discussed above), a microphone 84, a speaker 62 (FIG. 4) or other such trigger mechanism wherein the trigger mechanism is operably coupled to a programmable printed circuit board 86 (FIG. 4) or 186 (FIG. 10) disposed within the housing 35 of the powder dispenser assembly 10 adjacent the hopper 68. The trigger mechanism can activate the dispensing of a select powder directly or the trigger mechanism can be operably connected to a printed circuit board 86 and thereby communicate via signal with the printed circuit board 86 to activate the dispensing of a powder.

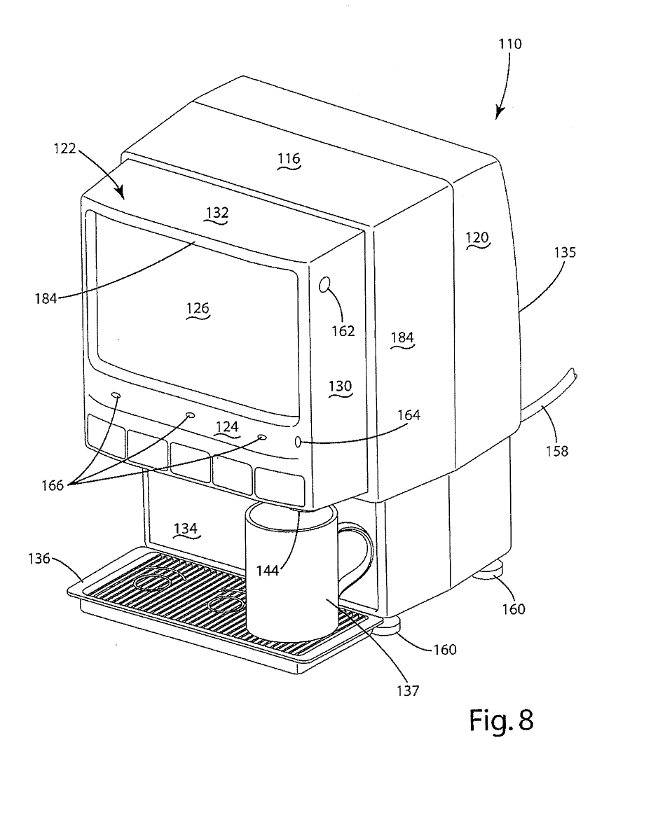

The printed circuit board 86 can be a programmable printed circuit board 86 which can initiate the dispensing of a powder, deliver a message to the user or both. Messages are delivered to the user through a media delivery system which is ether fully integrated with the printed circuit board 86, is a separate component of the powder dispensing assembly 10 without the need for the printed circuit board 86, or is operably connected to the printed circuit board 86. The media delivery system is capable of importing, storing, editing creating and delivering pre-recorded audio messages as well as importing, storing, editing and delivering video images and stills along with an audio component if desired. The printed circuit board 86 can also be programmed to import, store, edit and create audio messages to a user. The printed circuit board 86 and media delivery system can be programmed using different methods. For instance, a flash drive, jump drive, smart drive, SIM chip, or other portable memory storage unit can have specific messaging software downloaded onto the unit which can then be plugged into the media content delivery system or printed circuit board through a port such as a USB port or the like. The software can then be transferred to the media content delivery system or printed circuit board for use in delivering messages to the users of the dispensing assembly. The media content delivery system or printed circuit board may also be supplied software information by utilizing wireless technology which allows ad materials or messages that are displayed or played though the media content delivery system to be changed via a remote location at any time or moment. These and other features, advantages and objects of the present disclosure will be further understood and appreciated by referring to FIGS. 8-10.

Referring now to FIGS. 8-10, another embodiment of the present disclosure is shown. In this embodiment, the powder dispenser assembly 110 comprises side panels 112 (not shown) and 114, a top panel 116, a bottom panel 118 (not shown), a rear panel 120, a door 122, wherein the door 122 includes a front panel 124, side panels 128 (not shown) and 130, a top panel 132, a bottom panel 133 (not shown), and a display panel 126. The powder dispenser assembly 110 further includes a dispensing panel 134 and a drip tray 136. Similar to the embodiment in FIGS. 1-7, the door 122, the door panels, and the remaining panels described above, make up the housing 135 of the embodiment shown in FIGS. 8-10. As shown in FIG. 8, a coffee mug 137 is positioned on the drip tray 136 to receive the dry powder from the powder dispenser assembly 110. A power cord 158 is shown in FIG. 8 leaving the rear panel 120 of the powder dispenser assembly 110 through an access point. The embodiment shown in FIG. 8 further includes feet 160 generally comprising a rubberized material to provide non-slip contact between the powder dispenser assembly 110 and the surface on which the powder dispenser assembly 110 is placed. The embodiment in FIG. 8 further similarly includes an audible response speaker 162 capable of delivering a pre-recorded audio message to a user of the dispenser assembly 110 which is described in further detail below.

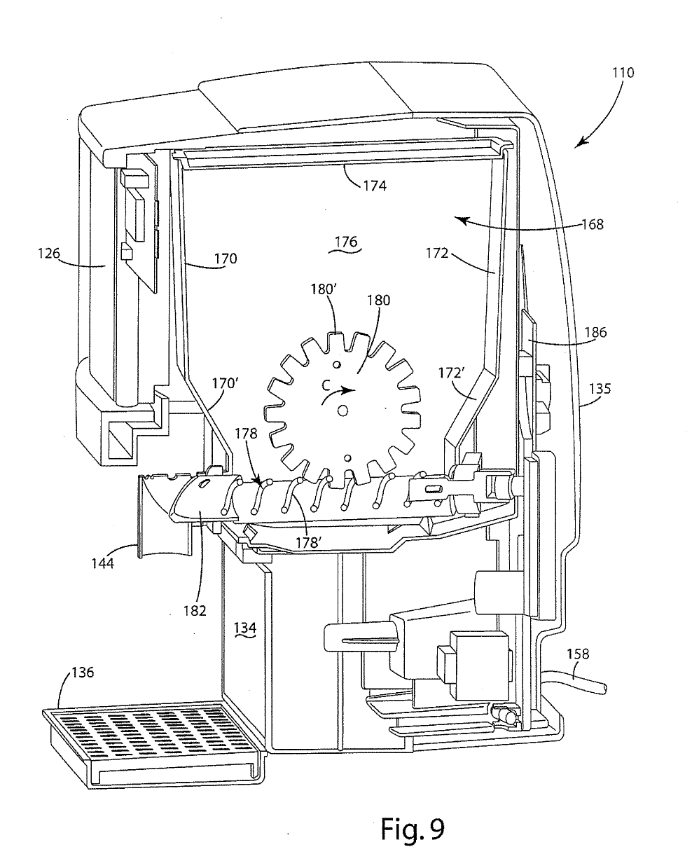

FIG. 9 is a cross-sectional view of the embodiment shown in FIG. 8. As shown in FIG. 9 a dry powder or granulated beverage concentrate (not shown) is contained within the housing of the powder dispenser assembly 110 in an elongate upwardly opening hopper 168 of a hopper assembly which has inwardly convergent vertical front and rear side walls 170 and 172, respectively, which have lower portions 170′ and 172′ which are inclined downwardly towards the center of the hopper 168. The hopper 168 further comprises a cover 174 which contains the dry powder when the powder dispenser assembly 110 is in operation. The front and rear walls 170 and 172 of the hopper 168, in conjunction with the cover 174, form a cavity 176 within the hopper 168. The hopper 168 is generally made of a food-grade plastic for safe containment of the dry powder.

The hopper 168 further includes a powder moving assembly, which in this embodiment (FIG. 9), is in the form of an elongate helical auger 178, which is powered by an electrically powered cog 180 having individual teeth 180′ which engage the auger 178 at the individual rings 178′ of the auger 178 such that as the cog 180 moves clockwise of the direction C as indicated, the teeth 180′ of the cog 180 engage the rings 178′ of the auger 178, thereby moving dry powder in contact with the auger rings 178′ to a transfer port 182 and then out of the dispenser assembly 110 through dispensing nozzles 144.

The system comprising the auger 178 and cog 180, hereinafter the auger system, can be activated in a number of ways using various trigger mechanisms. Referring to FIG. 8, the user of the powder dispenser assembly 110 can use the buttons 166 as a trigger mechanisms to activate the auger system. The buttons 166, when pressed, send a signal to the auger system which activates the cog 180 which activates the auger 178 as shown in FIG. 9. The dry powder is then dispensed through the dispenser nozzle 144 into the coffee mug 137. In this way, the trigger mechanism (the buttons 166) are acting directly with the auger system to dispense the powder without using a printed circuit board. A printed circuit board may still be incorporated to deliver a message once the trigger mechanism is triggered.

In the embodiment shown in FIG. 8, three buttons 166 are shown. Thus, the embodiment in FIG. 8 can have multiple separate hopper units 168 (not shown) in a hopper assembly disposed within the housing of the powder dispenser assembly 110, each having its own auger system, or other like powder moving assembly, which responds to the individual buttons 166, thus allowing the embodiment shown in FIG. 8 to dispense multiple different dry powders as selected by the user.

The embodiment shown in FIG. 8 may further comprise a microphone 184 as a trigger mechanism, which can send a signal to the printed circuit board 186 (FIG. 10) to digitally read or decode the voice of the user requesting the dispensing of a select dry powder from the powder dispenser assembly 110. In this embodiment, the microphone 184 is operatively coupled to the printed circuit board 186 which is programmed to respond and activate the powder moving assembly to dispense powder and can also activate an audible pre-recorded message to be delivered through the speaker 162. Where multiple hoppers are present in the hopper assembly, the printed circuit board 186 can be programmed to activate a select powder moving assembly of a particular hopper by the recognition of a unique vocal command such as “sugar.”

Alternatively, when the trigger mechanism is in the form of a sensory unit 164 (FIG. 8), the sensory unit 164 can be triggered by one of many known sensory techniques used to detect the presence of a person. Such sensory techniques include use of ultrasonic sensors, infrared sensors, optical sensors, motion sensors, heat sensors and the like. For example, in the embodiment shown in FIG. 8, the sensory unit 164 can detect the presence of a user thereby activating the powder dispenser assembly 110 such the powder dispenser assembly 110 is then prepared to take a request through the microphone 184 from the user. The printed circuit board 186, operably connected to the sensory unit 164, is programmed to digitally detect the selection made by the user through the microphone 184 and thus, dispenses the corresponding dry powder. The sensory unit 164 can also be used in combination with buttons 166, or the sensory unit 164 can be used in place of buttons 166, eliminating the need for buttons 166 altogether.

As shown in FIG. 10, the powder dispenser assembly 110 is shown wherein a portion of the rear panel 120 is removed to reveal the printed circuit board 186, much like printed circuit board 86 in the embodiment shown in FIGS. 1-7, disposed within the rear housing portion of the powder dispenser assembly 110 adjacent the hopper 168. The printed circuit board 186 is a programmable unit which allows the owner of the powder dispenser assembly 110 to play back a pre-recorded message or advertisement such that when a user of the powder dispenser assembly 110 activates the dispensing of a powder through various trigger mechanisms, such as buttons 166 or detection by the sensory unit 164, the printed circuit board 186 relays a signal which generates the pre-recorded audio message to be delivered to the user via a media content delivery system such as speaker 162. The printed circuit board 186 can be programmed to generate the pre-recorded message when the user of the powder dispenser assembly 110 presses one of the buttons 166 (as shown in FIG. 8) such that the pre-recorded message generated will correspond with unique pre-recorded messages tailored to the button 166 chosen by the user. In this way, multiple pre-recorded messages can be generated and delivered via the speaker 162 to the user of the powder dispenser assembly 110 upon the selection of the dry powder by the user. The powder dispenser assembly 110 can further be activated by a trigger mechanism such that a pre-recorded message is delivered to the user even if the user does not activate the dispensing of a power.

As noted above, the printed circuit board 186 is also programmable such that when the printed circuit board 186 has been activated and a pre-recorded message has been delivered, the printed circuit board 186 initiates a pre-set time period beginning when the printed circuit board senses that the pre-recorded audio message has ended. The printed circuit board then re-enables the microphone 184, the buttons 166, the sensory unit 164 or other trigger mechanism when this time period has elapsed. Thus, multiple pre-recorded audio messages are not sequentially repeated while the user is using the powder dispenser assembly 110.

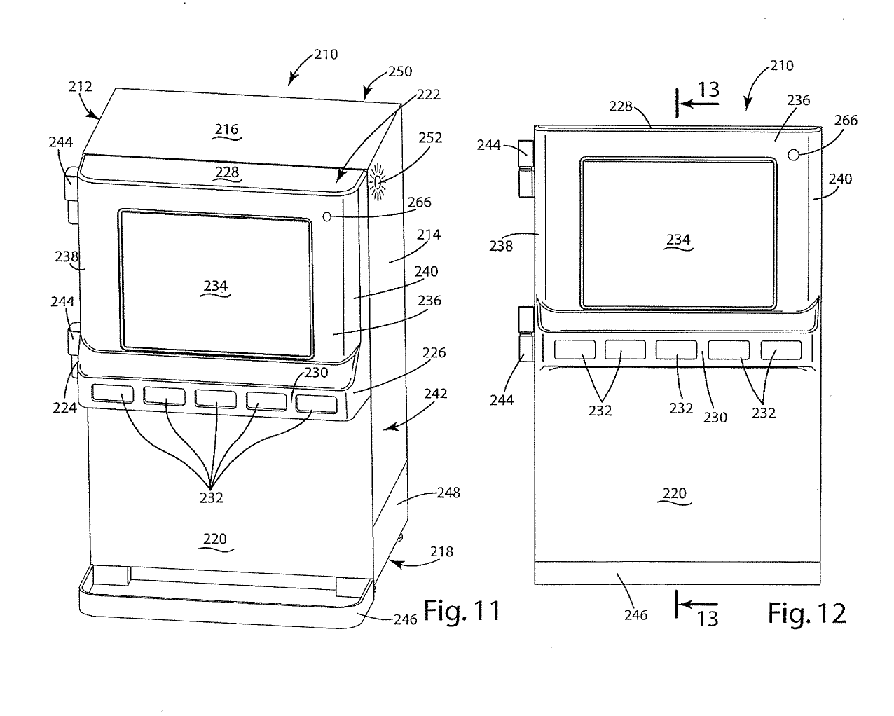

Turning to FIGS. 11-14, reference numeral 210 generally designates another embodiment of a powder dispenser assembly in accordance with the present disclosure. As shown in FIG. 11, this embodiment of the dispensing assembly 210 comprises side panels 212, 214, top panel 216, bottom panel 218, dispensing panel 220, door 222, door side panels 224, 226, door top panel 228, information panel 230, information panel boxes 232, display screen 234, display screen housing 236, and screen side panels 238 and 240. The panels noted above as well as the door and associate door panels comprise the housing 242 of the dispensing assembly 210. The door 222 is coupled to the housing 242 by hinges 244. The dispensing assembly 210 further comprises a drip tray 246 disposed at the lower end of dispensing panel 220. The housing further comprises base panels 248, which are disposed around the bottom portion of the side panels 212 and 214 and a back panel 250 (not shown) all of which are incorporated into the housing 242.

In this embodiment, the media content delivery system is a display screen 234 which is preferably a flat audiovisual display screen capable of showing still images, moving images, and delivering pre-recorded audio messages through a speaker 252 or through an internal mechanism (not shown) disposed on the display screen 234. The display screen 234 is akin to an LCD-based digital screen or digital photo frame such as those produced by manufacturers such as Kodak, Insignia, Sony, Shenzhen Welhope Enterprises, Ltd., Corey, GQ, Polaroid, Audiovox, Pan Digital, and the like. The display screen 234 of the present disclosure is capable of playing MP3s and other pre-recorded songs or messages, displaying digital videos and stills, and can have touch-screen capabilities as well. The display screen 234 is disposed within the door 222 of the dispensing assembly 210 and is encased by the display screen housing 236 for an aesthetically pleasing overall configuration. The display screen 234 is programmable and can display general information, such as time, date, weather, news, and the like, or the display screen 234 can also display specific product information relating to the powders housed within the powder dispensing assembly 210. The display screen 234 can also display advertising materials to advertise the store in which the powder dispensing assembly 210 is set up, or display advertising information from third parties who purchase advertising space on the powder dispensing assembly 210. The display screen 234 also has the ability to program advertising campaigns for certain time frames. For instance if the dispensing assembly 210 were located in a location that served breakfast, lunch and dinner, advertising materials could be displayed which are customized for that particular time of the day.

The display screen can be a standalone mechanism which integrally houses the triggering mechanism (such as touch screen buttons), media content delivery system (such as a speaker) and a programmable printed circuit board to initiate powder dispensing and deliver messages to the user.

It is contemplated that the display screen can be provided with media content in a number of ways. The media content can be provided with a with a flash drive, jump drive, smart drive, SIM chip, etc. which are plugged into a USB port on the display screen and changed as often as desired, for example, hourly, weekly, bi-weekly, or monthly. The operator of the device could download interchangeable media content to such thumb drive technology via an FTP site. Alternatively, the screen may be supplied or downloaded by using wireless technology that would allow the media content displayed on the screen to be changed via a remote location at any time, day or night. The owner of the location, be it a hotel, store, casino, coffee shop, etc., could thus download the information from a computer USB port with a 24-hour scrolling media content supplied through an FTP site dedicated to that particular location. Time frames for the day could be changed by a hand-held remote control device, manually changing the screen through the buttons or touch-pad screen technology.

As shown in FIGS. 11 and 12, the powder dispensing assembly 210 comprises an information panel 230 having information panel boxes 232 disposed thereon. The information panel boxes 232 can display information regarding the types of dry powder available in the dry powder dispensing assembly 210 or can be used to house triggering mechanisms, such as buttons for the selection of a particular dry powder. Buttons for selection of dry powder can also be disposed on the display screen 234 in the form of touch-screen capable buttons activated by the user.

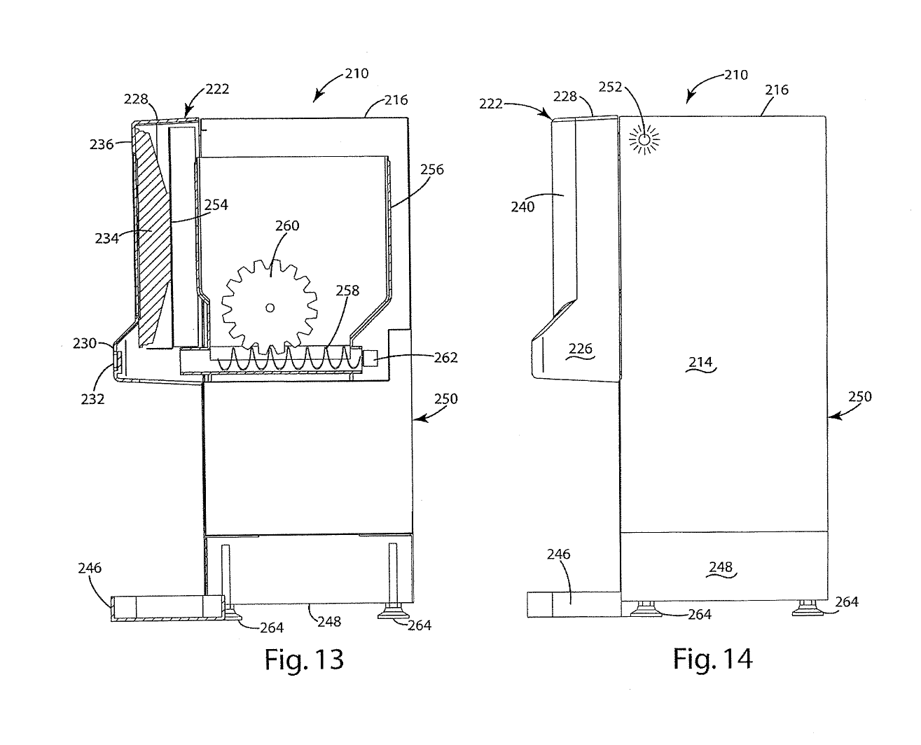

As shown in FIG. 13, the cross-sectional view of the powder dispensing assembly 210 shows that the display screen 234 is rigidly affixed to the door 222 by a display screen bracket 254. The door 222 is moveable between a closed position (as shown in FIG. 13) and an open position (not shown). When the door 222 is in the open position, the display screen bracket 254 and the display screen 234 are accessible to the user. As further shown in FIG. 13, the powder dispensing assembly 210 further comprises a hopper assembly having a hopper 256 disposed within the housing 242 of the powder dispensing assembly 210 adjacent the door 222. The dispensing assembly 210 includes a powder moving system similar to the powder moving systems discussed in the embodiments noted above. As shown in FIG. 13, the powder moving system is in the form of an elongate helical auger 258, which is actuated by a cog 260 or a motor 262 in a similar fashion as the embodiments noted above.

As shown in FIGS. 13 and 14, it is noted that the powder dispensing assembly 210 further comprises adjustable legs 264, which can be adjusted to ensure that the powder dispensing assembly 210 is level on the surface where it is installed.

The embodiment shown in FIGS. 11-14 also comprises a trigger mechanism which can be in the form of an integral component of the display screen 234, buttons disposed in the informational panel boxes 232, or a sensory unit 266 (FIGS. 11 and 12), or the like for triggering the powder moving assembly. Similar to the embodiments disclosed above, the embodiment shown in FIGS. 11-14 further comprises a printed circuit board (not shown) which is capable of being triggered by a trigger mechanism to activate the powder moving assembly or the trigger mechanisms can activate the powder moving assembly alone. The trigger mechanisms can also trigger the playing of a pre-recorded message or other like audiovisual display on the display screen 234 when activated.

The powder dispensing assembly 210 is designed to play customized, pre-recorded audio and visual messages particular to the environment in which the powder dispensing assembly is located. For example, if the powder dispensing assembly 210 is located within an office environment, the audio or visual messages can be programmed to be delivered with a reduced volume or no volume at all, and the audio or visual message can be programmed to run for a short period of time at some point during the duration of the user's use of the powder dispensing assembly 210. In a commercial environment, such as a convenience store or the like, the powder dispensing assembly 210 can be programmed to run constant audio or visual messages to deliver such messages to the user of the powder dispensing assembly 210 or to attract the attention of other store customers. The display screens 234 are also contemplated to be of variable sizes such that a powder dispensing assembly 210 can have a smaller display screen 234 disposed within the door 222 for a less-conspicuous audio or visual message delivery when desired.

While it is primarily contemplated that the powder dispensing assembly of the present disclosure is used to dispense a dry powder to the user, it is further contemplated by the present disclosure that the powder dispensing assemblies discussed above can be advantageously employed in providing a dry powder to a subsequent mixing chamber, wherein the dry powder is mixed with suitable fluids, such as water, to constitute a finished beverage which is then provided to the user. Thus, it is contemplated that the present disclosure could be advantageously employed in beverage dispensers that provide a finished beverage to the end user.

The present disclosure also provides a method for delivering point-of-use messages to the user of a powder dispenser assembly 110, wherein the delivered message can be in the form of advertising information from businesses or general information such as date and time at a point-of-use between the customer and the powder dispenser assembly 110. The steps for this method of advertising include (a) providing a dry powdered dispensing machine having a housing, a trigger mechanism, a printed circuit board and a media content delivery system (b) triggering the trigger mechanism of the dry powdered dispensing machine using a trigger mechanism such as sensory detection of the presence of a user or the user's mechanical or voice activation of the trigger mechanism; (c) sending a signal to the printed circuit board from the triggering mechanism (d) sending a signal from the printed circuit board to a media content delivery system and (e) delivering a message to the user wherein the message is in the form of an audio, visual, or audiovisual message.

The above description is considered of preferred embodiments only. Modifications of the disclosed powder dispensing assembly will occur to those skilled in the art and to those who make or use the disclosed powder dispensing assembly. Therefore, it is understood that the embodiments shown in the drawings and described above are merely for illustrative purposes and not intended to limit the scope of the disclosure.

What is claimed is:

1. A powder dispensing assembly, comprising:
a housing;
a hopper assembly disposed within the housing comprising at least one hopper and at least one a powder moving assembly;
at least one outlet passage;
a trigger mechanism;
a printed circuit board operably connected to the trigger mechanism; and
a media content delivery system capable of providing at least one of an audio and video message.

2. The powder dispensing assembly of claim 1, wherein the hopper assembly further comprises a plurality of hoppers wherein each hopper comprises a powder moving assembly.

3. The powder dispensing assembly of claim 1, wherein the at least one powder moving assembly is an auger.

4. The powder dispensing assembly of claim 1, wherein the trigger mechanism is a button disposed on the exterior of the housing.

5. The powder dispensing assembly of claim 1, wherein the trigger mechanism is a sensory unit.

6. The powder dispensing assembly of claim 5, wherein the sensory unit is a sensory unit selected from the group consisting of an ultrasonic sensor, an infrared sensor, an optical sensor, a motion sensor or a heat sensor.

7. The powder dispensing assembly of claim 1, wherein the trigger mechanism is a microphone.

8. The powder dispensing assembly of claim 1, wherein the printed circuit board is a programmable printed circuit board capable of editing, storing, importing, modifying, or creating audio messages.

9. The powder dispensing assembly of claim 1, wherein the printed circuit board is a programmable printed circuit board capable of editing, storing, importing, modifying, or creating audiovisual messages.

10. The powder dispensing assembly of claim 1, wherein the media content delivery system is a speaker capable of delivering an audio message.

11. The powder dispensing assembly of claim 1, wherein the media content delivery system is a display screen capable of delivering a message.

12. The powder dispensing assembly of claim 11, wherein the message is an audiovisual message.

13. The powder dispensing assembly of claim 11, wherein the display screen is a programmable display screen capable of editing, storing, importing, modifying, or creating messages.

14. A method of delivering a point-of-use message to a user, comprising:
providing a dry powder dispensing assembly having a housing, a trigger mechanism, a printed circuit board, and a media content delivery system capable of providing at least one of an audio and video message;
triggering the trigger mechanism;
sending a signal from the trigger mechanism to the printed circuit board;
sending a signal from the printed circuit board to the media content delivery system; and
delivering a message to the user.

15. The method of claim 14, wherein the step of providing a dry powder dispensing assembly further comprises:
providing a dry powder dispensing assembly having a trigger mechanism wherein the trigger mechanism is selected from the group consisting of a sensory unit, a microphone, or a button disposed on the exterior of the housing.

16. The method of claim 14, wherein the step of providing a dry powder dispensing assembly further comprises:
providing a dry powder dispensing assembly having a printed circuit board wherein the printed circuit board is a programmable printed circuit board capable of editing, storing, importing, modifying, or creating messages.

17. The method of claim 14, wherein the step of providing a dry powder dispensing assembly further comprises:
providing a dry powder dispensing assembly having a media content delivery system wherein the media content delivery system is a speaker.

18. The method of claim 14, wherein the step of providing a dry powder dispensing assembly further comprises:
providing a dry powder dispensing assembly having a media content delivery system wherein the media content delivery system is a display screen.

19. The method of claim 14, wherein the step of delivering a message to the user further comprises:
delivering a message to the user wherein the message is a message selected from the group consisting of an audio message or an audiovisual message.

20. A powder dispensing assembly for use by an end user, comprising:
a hopper assembly comprising at least one hopper for storing a dry powder and at least one powder moving assembly;
at least one trigger mechanism;
a printed circuit board operably connected to the trigger mechanism and capable of being triggered by the triggering mechanism; and
at least one media content delivery system operably coupled to the printed circuit board and capable of being activated by the printed circuit board to deliver a message to a user.

21. The powder dispenser assembly of claim 20, wherein the dry powder is delivered to the end user.

22. The powder dispenser assembly of claim 20, further comprising a mixing chamber and a fluid source, and wherein the dry powder is delivered to the mixing chamber along with the fluid and a finished beverage is delivered to the end user.

23. A powder dispensing assembly, comprising:
a housing;
a hopper assembly disposed within the housing comprising at least one hopper and at least one a powder moving assembly;
at least one outlet passage;
a media content delivery system capable of providing at least one of an audio and video message wherein the media content delivery system is connected wirelessly to a network connection for downloading media.
